(19) United States
(12) Patent Application Publication
(10) Pub. No.: US 2025/0041818 A1
(43) Pub. Date: Feb. 6, 2025

(54) BIMETALLIC SYNERGISTIC RUBBER ACCELERATOR AND ITS PREPARATION METHOD, AND A RUBBER PRODUCT

(71) Applicant: XINJI BAOLONG TECHNOLOGY CO., LTD., Shijiazhuang City (CN)

(72) Inventors: Dong HEXIANG, Xi'an City (CN); Ma Di, Xi'an City (CN); Song Yunying, Xi'an City (CN); Yang Tong, Xi'an City (CN); Chao Zhu, Xi'an City (CN)

(21) Appl. No.: 18/664,204

(22) Filed: May 14, 2024

(30) Foreign Application Priority Data
Jul. 31, 2023 (CN) 2023109508102

(51) Int. Cl. B01J 13/00; C08K 3/04; C08K 3/06; C08K 3/28; C08K 3/36; C08K 5/06; C08K 5/14; C08L 7/00; C08L 9/02

(52) U.S. Cl. CPC B01J 13/0008; B01J 13/0052; C08K 3/04; C08K 3/06; C08K 3/28; C08K 3/36; C08K 5/06; C08K 5/14; C08L 7/00; C08L 9/02

(57) ABSTRACT

The present application relates to rubber accelerators, and specifically disclosed are a bimetallic synergistic rubber accelerator, a preparation method thereof, and a rubber product. The preparation method of the accelerator includes the following steps: Step S1, preparing a pre-precursor powder by a sol-gel method; Step S2, performing microwave synthesis; the Step S1 specifically includes the following steps: Step S11: dissolving a cobalt salt and a manganese salt in water, adding polyethylene glycol and then stirring evenly, and adjusting the pH to 7.5-8 with an alkali solution to obtain an initial reaction solution; Step S12: reacting the initial reaction solution at 50-70° C., then drying to obtain a xerogel, and then pulverizing and screening to obtain the pre-precursor powder. The accelerator of the present application can be used to prepare rubber products. The accelerator has the advantages of shortening the vulcanization time and improving the overall performance of the rubber products.

### TECHNICAL FIELD

The present application relates to the technical field of rubber accelerators, more specifically, it relates to a bimetallic synergistic rubber accelerator and a preparation method thereof, and a rubber product.

### BACKGROUND ART

In the production process of rubber products, activators, accelerators, antioxidants, vulcanizing agents, and the like are needed to form a complete rubber vulcanization system, in which the role of an accelerator is to accelerate vulcanization, reduce the amount of accessary materials such as activators and vulcanizing agents, shorten the vulcanization time, and improve the physical properties and stability of rubber products.

There are only a few types of traditional rubber accelerators, such as vulcanized phthalamide (CBS), N-tert-butyl-2-benzothiazole sulfonamide (TBBS), etc. However, these accelerators have limited accelerating effects and cannot meet the needs of high-performance rubber products. The newly developed bimetallic synergistic rubber accelerator can improve the accelerating effect and enhance the tensile strength, wear resistance and other comprehensive properties of rubber products.

However, existing bimetallic accelerators have problems such as difficult to control the ratio, poor dispersion, and poor stability, which can lead to certain poor overall properties of the rubber products prepared with the bimetallic accelerators, including poor vulcanization time, elongation at break, tensile strength, elasticity (elongation, resilience, etc.) and hardness.

### SUMMARY OF THE INVENTION

In order to improve the overall performance of rubber after using a bimetallic accelerator, the present application provides a bimetallic synergistic rubber accelerator, a preparation method thereof, and a rubber product.

In a first aspect, the present application provides a method for preparing a bimetallic synergistic rubber accelerator, which employs the following technical solution:
A method for preparing a bimetallic synergistic rubber accelerator includes the following steps: Step S1, preparing a pre-precursor powder by a sol-gel method; Step S2, performing microwave synthesis;
the Step S1 specifically includes the following steps:

Step S11: dissolving a cobalt salt and a manganese salt in water, adding polyethylene glycol and then stirring evenly, and adjusting the pH to 7.5-8 with an alkali solution to obtain an initial reaction solution;
Step S12: reacting the initial reaction solution at 50-70° C., then drying to obtain a xerogel, and then pulverizing and screening to obtain the pre-precursor powder; the Step S2 specifically includes the following steps:

mixing the pre-precursor powder and a sulfur powder evenly, then reacting in a microwave environment, and then screening to obtain the bimetallic synergistic rubber accelerator.

By employing the above technical solution, the pre-precursor powder is firstly prepared by a sol-gel method; in this preparation process, by means of selecting two appropriate metal salts and reacting them at a certain temperature, a pre-precursor powder with high reactivity is obtained. The powder has uniform particle size and high activity. It can have high reactivity in the solid phase reaction with sulfur powder in the later stage, and produce an accelerator with excellent vulcanization acceleration effect.

In Step S12 of the above solution, it is recommended that the reaction be carried out under conditions that make the solvent less volatile; for example, the reaction is carried out in a closed reactor.

Optionally, in Step S11, when the cobalt salt and the manganese salt are dissolved in water, a molar ratio of cobalt ions to manganese ions is 1: (1-3).

Preferably, in Step S11, when the polyethylene glycol is added, a content of the polyethylene glycol made to 1.5-3.0 wt %.

Preferably, the cobalt salt is any one or more selected from cobalt nitrate, cobalt chloride and cobalt phosphate; and the manganese salt is any one or more selected from manganese acetate, manganese carbonate and manganese sulfate.

By employing the above technical solution, when the molar ratio of cobalt ions to manganese ions is 1: (1-3), the accelerator obtained can have relatively high reactivity to prepare rubber products with excellent performance. The molar ratio of cobalt ions to manganese ions affects the distribution coefficient of cobalt ions and manganese ions. Different distribution of cobalt ions and manganese ions can result in different activity of the accelerator obtained. In the case where there are many cobalt ions and too few manganese ions, or too few cobalt ions and too many manganese ions, when the accelerator obtained is used to prepare rubber products, the resulting rubber products may have cross-linking, as well as poor strength and other properties. Optionally, the reaction time in Step S12 is 20-30 h.

Preferably, the reaction temperature in Step S12 is 50-60° C.

In the above solution, the reaction temperature is 50-70° C., and the accelerator produced has good effects on accelerating vulcanization, which ensures that the obtained rubber products have excellent product properties (including mechanical properties, hardness and elasticity, etc.) with a short vulcanization time. When the reaction temperature changes within the range of 60-70° C., the performance improvement of rubber products made with this accelerator is not significant, but still remains at a high level; however, a high reaction temperature results in high energy consumption. In this regard, from the perspective of production cost, the reaction temperature in Step S12 is set as 50-60° C.

Optionally, the particle size D of the pre-precursor powder after screening in Step S12 is: 0<D<100 meshes.

By employing the above technical solution, when the pre-precursor powder is controlled within the above range, it has a relatively large specific surface area and reactivity. After reacting with sulfur powder, it has a better effect of accelerating vulcanization.

Optionally, the microwave environment in Step S2 includes: a temperature is 195-205° C., a microwave processing time is 5-15 min, and a microwave power is 700-900 W.

Preferably, the microwave synthesis in Step S2 is performed in a vacuum environment.

Optionally, the pre-precursor powder and sulfur powder in Step S2 are mixed at a weight ratio of 1: (1.5-3.5).

Optionally, in Step S2, after the microwave synthesis is performed, a cooling step is further performed on the product. The cooling step includes the steps of cooling the product naturally to below 80° C., and then cooling the product with cold water.

Optionally, the bimetallic synergistic rubber accelerator is used after the screening, and after the screening, a particle size Dt of the bimetallic synergistic rubber accelerator is: 0<Dt<100 meshes.

It has been found in the experiments that the particle size of the bimetallic synergistic rubber accelerator obtained herein has a relatively great impact on the vulcanization acceleration effect. When the particle size of the bimetal synergistic rubber accelerator is controlled within the range set forth above, the bimetallic synergistic rubber accelerator has high particle uniformity, large specific surface area and high reactivity. Therefore, by adopting the above technical solutions, when the bimetal synergistic rubber accelerator is used to prepare rubber products, rubber products with excellent performance with a short vulcanization time can be obtained.

In a second aspect, the present application provides a bimetallic synergistic rubber accelerator, by employing the following technical solution:

A bimetal synergistic rubber accelerator is provided; the accelerator is prepared using the preparation method set forth above.

In a third aspect, the present application provides a rubber product by employing the following technical solution:

A rubber product is provided; the raw materials for preparing the rubber products include the bimetallic synergistic rubber accelerator set forth above.

Optionally, when the rubber product is a natural rubber product, the rubber product includes the following raw materials in parts by weight: 100 parts of natural rubber, 0.5-3.5 parts of metal the synergistic rubber accelerator, 0.2-0.8 parts of a vulcanizing agent, and 23-36 parts of an inorganic filler.

Preferably, the vulcanizing agent is sulfur powder, and the inorganic filler is white carbon black.

Optionally, when the rubber product is a nitrile rubber product, the rubber product includes the following raw materials in parts by weight: 100 parts of nitrile rubber, 2-4 parts of the metal synergistic rubber accelerator, 0.2-1.4 parts of a vulcanizing agent, and 30-50 parts of an inorganic filler.

Preferably, the vulcanizing agent is a peroxide vulcanizing agent, and the inorganic filler is silica powder.

In summary, the present application has the following beneficial effects:

1. In the present application, a specific bimetal combination is selected to prepare an accelerator that has a short vulcanization time and can significantly improve the overall performance of rubber products. In the process of preparing the metal synergistic rubber accelerator, the product is prepared by sol-gel method combined with microwave synthesis. In this way, the sol-gel method can fully disperses the metal raw materials so that they can be combined with sulfur powder in a more stable and appropriate proportion and position. This enables the metal synergistic rubber accelerator to exert excellent vulcanization accelerating effect, significantly reduce vulcanization time, and improve the overall performance of rubber products.

2. The present application further controls the powder particle size of the metal synergistic rubber accelerator obtained, so as to obtain an accelerator with high surface activation energy, which allow the accelerator to exert excellent vulcanization acceleration functions.

### DESCRIPTION OF THE EMBODIMENTS

The present application will be further described in detail below in conjunction with certain examples. In addition, special instructions are given as follows: if no specific conditions are specified in the following examples, the reactions or processes should be carried out in accordance with conventional conditions or conditions recommended by the manufacturers. The raw materials used in the following examples can all be obtained from commonly available sources unless otherwise specified.

### Measurement Methods

With reference to GB/T16584-1996 “Method for determination of vulcanization characteristics of rubber with rotorless vulcanizer,” the vulcanization time of the rubber product is measured. With reference to the method set forth in GB/T529-2008 “Determination of tear strength of vulcanized rubber or thermoplastic rubber,” the tear strength of the rubber products is measured. With reference to the method set forth in GB1040.1-2006, the elongation at break of the rubber products is measured. With reference to the method set forth in GB/T6031-1998 “Determination of hardness of vulcanized rubber or thermoplastic rubber,” the hardness of the rubber products is measured. With reference to GB/T528-1998 “Method for determination of tensile stress and strain properties of vulcanized rubber or thermoplastic rubber,” the tensile stress and strain properties of the rubber products are measured.

### Examples of the Accelerator

### Example 1

A method for preparing a bimetallic synergistic rubber accelerator, the method specifically includes:
Step S1: preparing a pre-precursor powder by a sol-gel method;
the Step S1 specifically includes:
Step S11: dissolving 1.7 mmol cobalt nitrate (Co(NO₃)₂) and 1.7 mmol manganese acetate (Mn(CH₃COO)₂) in 40 mL deionized water; adding polyethylene glycol (PEG) with a molecular weight of 20,000 to make the mass fraction of polyethylene glycol as 1.5 wt %; then stirring for 30 min at 400 rpm to make the solution uniform; and then titrating with 1 mol/L ammonia water to adjust the pH of the solution to 7.5-8, so as to obtain an initial reaction solution;
Step S12: placing the initial reaction solution obtained in S11 into a closed reactor, reacting at a constant temperature of 50° C. for 30 h with stirring at 350 rpm; then transferring the reactant to an oven, setting the drying temperature to 50° C., and drying with hot air circulation for 14 h to obtain a xerogel; and then pulverizing the xerogel with a grinder and passing it through a sieve of 100 meshes, collecting the undersized material, so as to obtain the pre-precursor powder;
Step S2: performing microwave synthesis;
the Step S2 specifically includes:
evenly mixing 3 g of the obtained pre-precursor powder and 4.5 g of sulfur powder; then transferring the mixed powder to a microwave reactor; then fully evacuating the microwave reactor to reduce the pressure to below 5 Pa to remove air and the solvent; setting the heating rate to 10° C./min, raising the temperature to 195° C. and keeping at the foregoing temperature for 15 min; next naturally cooling to 75° C., and then placing the microwave reactor in deionized water for soaking and cooling, after cooling, taking out the reaction product and passing it through a sieve of 100 meshes, so as to obtain the bimetallic synergistic rubber accelerator.

### Example 2

A method for preparing a bimetallic synergistic rubber accelerator, the method specifically includes:
Step S1: preparing a pre-precursor powder by a sol-gel method;
the Step S1 specifically includes:
Step S11: dissolving 2.5 mmol cobalt nitrate (Co(NO₃)₂) and 2.5 mmol manganese acetate (Mn(CH₃COO)₂) in 40 mL deionized water; adding polyethylene glycol (PEG) with a molecular weight of 20,000 to make the mass fraction of polyethylene glycol as 2.2 wt %; then stirring for 25 min at 500 rpm to make the solution uniform; and then titrating with 1 mol/L ammonia water to adjust the pH of the solution to 7.5-8, so as to obtain an initial reaction solution;
Step S12: placing the initial reaction solution obtained in S11 into a closed reactor, reacting at a constant temperature of 55° C. for 25 h with stirring at 400 rpm; then transferring the reactant to an oven, setting the drying temperature to 55° C., and drying with hot air circulation for 12 h to obtain a xerogel; and then pulverizing the xerogel with a grinder and passing it through a sieve of 100 meshes, collecting the undersized material, so as to obtain the pre-precursor powder;
Step S2: performing microwave synthesis;
the Step S2 specifically includes:
evenly mixing 5 g of the obtained pre-precursor powder and 10 g of sulfur powder; then transferring the mixed powder to a microwave reactor; then fully evacuating the microwave reactor to reduce the pressure to below 5 Pa to remove air and the solvent; setting the heating rate to 13° C./min, raising the temperature to 200° C. and keeping at the foregoing temperature for 10 min; next naturally cooling to 70° C., and then placing the microwave reactor in deionized water for soaking and cooling, after cooling, taking out the reaction product and passing it through a sieve of 100 meshes, so as to obtain the bimetallic synergistic rubber accelerator.

### Example 3

A method for preparing a bimetallic synergistic rubber accelerator, the method specifically includes:
Step S1: preparing a pre-precursor powder by a sol-gel method;
the Step S1 specifically includes:
Step S11: dissolving 1.7 mmol cobalt nitrate (Co(NO₃)₂) and 5.1 mmol manganese acetate (Mn(CH₃COO)₂) in 40 mL deionized water; adding polyethylene glycol (PEG) with a molecular weight of 20,000 to make the mass fraction of polyethylene glycol as 3.0 wt %; then stirring for 15 min at 600 rpm to make the solution uniform; and then titrating with 1 mol/L ammonia water to adjust the pH of the solution to 7.5-8, so as to obtain an initial reaction solution;
Step S12: placing the initial reaction solution obtained in S11 into a closed reactor, reacting at a constant temperature of 70° C. for 20 h with stirring at 450 rpm; then transferring the reactant to an oven, setting the drying temperature to 70° C., and drying with hot air circulation for 10 h to obtain a xerogel; and then pulverizing the xerogel with a grinder and passing it through a sieve of 100 meshes, collecting the undersized material, so as to obtain the pre-precursor powder;
Step S2: performing microwave synthesis;
the Step S2 specifically includes:
evenly mixing 3 g of the obtained pre-precursor powder and 10.5 g of sulfur powder; then transferring the mixed powder to a microwave reactor; then fully evacuating the microwave reactor to reduce the pressure to below 5 Pa to remove air and the solvent; setting the heating rate to 15° C./min, raising the temperature to 205° C. and keeping at the foregoing temperature for 5 min; next naturally cooling to 78° C., and then placing the microwave reactor in deionized water for soaking and cooling, after cooling, taking out the reaction product and passing it through a sieve of 100 meshes, so as to obtain the bimetallic synergistic rubber accelerator.

### Examples 4-7

The difference between Examples 4-7 and Example 2 is that when the pre-precursor powder is prepared by the sol-gel method, the molar ratio of cobalt nitrate to manganese acetate is different.

Specifically, the molar ratio of cobalt nitrate to manganese acetate in Example 4 is 1:0.5, that is, the cobalt nitrate is 2.5 mmol and the manganese acetate is 1.3 mmol.

In Example 5, the molar ratio of cobalt nitrate to manganese acetate is 1:2, that is, the cobalt nitrate is 2.5 mmol and the manganese acetate is 5 mmol.

In Example 6, the molar ratio of cobalt nitrate to manganese acetate is 1:3, that is, the cobalt nitrate is 2.5 mmol and the manganese acetate is 7.5 mmol.

In Example 7, the molar ratio of cobalt nitrate to manganese acetate is 1:4, that is, the cobalt nitrate is 2.5 mmol and the manganese acetate is 10 mmol.

### Examples 8-10

The difference between Examples 8-10 and Example 2 is that when the pre-precursor powder is prepared by the sol-gel method, the reaction temperature in Step S12 is different. Specifically, the reaction temperature in Example 8 is 50° C.; the reaction temperature in Example 9 is 60° C.; and the reaction temperature in Example 10 is 70° C.

### Examples 11-14

The difference between Examples 11-14 and Example 2 is that during microwave synthesis, the weight ratio of the pre-precursor powder to the sulfur powder is different.

Specifically, the weight ratio of the pre-precursor powder to the sulfur powder in Example 11 is 1:0.5, that is, the weight of the pre-precursor powder is 5 g and the weight of the sulfur powder is 2.5 g.

In Example 12, the weight ratio of the pre-precursor powder to the sulfur powder is 1:1.5, that is, the weight of the pre-precursor powder is 5 g and the weight of the sulfur powder is 7.5 g. In Example 13, the weight ratio of the pre-precursor powder to the sulfur powder is 1:3.5, that is, the weight of the pre-precursor powder is 5 g and the weight of the sulfur powder is 17.5 g.

In Example 14, the weight ratio of the pre-precursor powder to the sulfur powder is 1:4.5, that is, the weight of the pre-precursor powder is 5 g and the weight of the sulfur powder is 22.5 g.

### Examples 15-16

The difference between Examples 15-16 and Example 2 is that the particle size Dt of the bimetallic synergistic rubber accelerator is different.

Specifically, in Example 15, the particle size Dt of the bimetallic synergistic rubber accelerator is 0<Dt<80 meshes, that is, the screening is carried out with screened with a sieve of 80 meshes, and the undersized material is taken.

Specifically, in Example 16, the particle size Dt of the bimetallic synergistic rubber accelerator is 0<Dt<60 meshes, that is, the screening is carried out with screened with a sieve of 60 meshes, and the undersized material is taken.

### COMPARATIVE EXAMPLES

### Comparative Example 1

The difference between this comparative example and Example 2 is that when the pre-precursor powder is prepared by the sol-gel method, the reaction temperature in Step S12 is different; the specific reaction temperature is 45° C. in this comparative example.

### Comparative Example 2

The difference between this comparative example and Example 2 is that when preparing the pre-precursor powder by the sol-gel method, different metal salts are selected. In this comparative example, copper sulfate and zinc sulfate are specifically selected.

Specifically, Step S1: preparing a pre-precursor powder by a sol-gel method Step S1 specifically includes:
Step S11: dissolving 2.5 mmol copper sulfate (CuSO4) and 2.5 mmol zinc sulfate (ZnSO4) in 40 mL deionized water; adding polyethylene glycol (PEG) with a molecular weight of 20,000 to make the mass fraction of polyethylene glycol as 2.2 wt %; then stirring for 25 min at 500 rpm to make the solution uniform; and then titrating with 1 mol/L ammonia water to adjust the pH of the solution to 7.5-8, so as to obtain an initial reaction solution;
Step S12: placing the initial reaction solution obtained in S11 into a closed reactor, reacting at a constant temperature of 55° C. for 25 h with stirring at 400 rpm; then transferring the reactant to an oven, setting the drying temperature to 65° C., and drying with hot air circulation for 12 h to obtain a xerogel; and then pulverizing the xerogel with a grinder and passing it through a sieve of 100 meshes, collecting the undersized material, so as to obtain the pre-precursor powder.

### Comparative Example 3

The difference between this comparative example and Example 3 is that when preparing the pre-precursor powder by the sol-gel method, different metal salts are selected. In this comparative example, ferric chloride and nickel sulfate are specifically selected.

Specifically, Step S1: preparing a pre-precursor powder by a sol-gel method
Step S1 specifically includes:
Step S11: dissolving 2.5 mmol ferric chloride (FeCl₃) and 2.5 mmol nickel sulfate (NiSO₄) in 40 mL deionized water; adding polyethylene glycol (PEG) with a molecular weight of 20,000 to make the mass fraction of polyethylene glycol as 2.2 wt %; then stirring for 25 min at 500 rpm to make the solution uniform; and then titrating with 1 mol/L ammonia water to adjust the pH of the solution to 7.5-8, so as to obtain an initial reaction solution;
Step S12: placing the initial reaction solution obtained in S11 into a closed reactor, reacting at a constant temperature of 55° C. for 25 h with stirring at 400 rpm; then transferring the reactant to an oven, setting the drying temperature to 65° C., and drying with hot air circulation for 12 h to obtain a xerogel; and then pulverizing the xerogel with a grinder and passing it through a sieve of 100 meshes, collecting the undersized material, so as to obtain the pre-precursor powder.

### Examples of Rubber Products

The following examples of rubber products are obtained from natural rubber as the raw material, specifically involving the natural rubber products prepared based on Examples 1-16 and the natural rubber products prepared based on Comparative Examples 1-4.

### Examples of Natural Rubber Products

### Example 1

The raw materials and the specific amounts thereof for preparing this natural rubber product is as follows: 100 g of a natural rubber, 0.5 g of an accelerator, 0.2 g of sulfur powder, and 23 g of white carbon black, where the accelerator is the bimetallic synergistic rubber accelerator prepared using the method set forth in Example 1. The natural rubber is specifically a natural rubber film, which is prepared by cutting with a knife and then mixing with other raw materials in an internal mixer.

The preparation method of the natural rubber products is as follows: premixing the entire above accelerator into white carbon black, then blending the mixture with the above amount of natural rubber for 5 min, and then adding the entire sulfur powder and mixing for 2 min, where an XK-160 open mill is used for mixing, the mixing process parameters are as follows: mixing at room temperature for 5 min at a rotating speed of 20 rpm with a roller distance of 2 mm, and triangle packing at least 3 times; then calendaring using a q160 double-roller rocking calender for shaping, where the process parameters for calendaring are as follows: the temperature is set lower than 70° C., the equipment operation lead coefficient P=1.1 (a ratio of the material outlet speed to the roller linear speed), and the roller speed ratio is 1.1-1.3; and finally, vulcanizing the product at 150° C. for 10 min, so as to obtain the natural rubber product.

### Example 2

The raw materials and the specific amounts thereof for preparing this natural rubber product is as follows: 100 g of a natural rubber, 2.0 g of an accelerator, 0.5 g of sulfur powder, and 30 g of white carbon black, where the accelerator is the bimetallic synergistic rubber accelerator prepared using the method set forth in Example 2.

The preparation method of the natural rubber products is as follows: premixing the entire above accelerator into white carbon black, then blending the mixture with the above amount of natural rubber for 5 min, and then adding the entire sulfur powder and mixing for 2 min, where an XK-160 open mill is used for mixing, the mixing process parameters are as follows: mixing at room temperature for 4 min at a rotating speed of 25 rpm with a roller distance of 2 mm, and triangle packing at least 3 times; then calendaring using a 160 double-roller rocking calender for shaping, where the process parameters for calendaring are as follows: the temperature is set lower than 70° C., the equipment operation lead coefficient P=1.1 (a ratio of the material outlet speed to the roller linear speed), and the roller speed ratio is 1.1-1.3; and finally, vulcanizing the product at 150° C. for 10 min, so as to obtain the natural rubber product.

### Example 3

The raw materials and the specific amounts thereof for preparing this natural rubber product is as follows: 100 g of a natural rubber, 3.5 g of an accelerator, 0.8 g of sulfur powder, and 36 g of white carbon black, where the accelerator is the bimetallic synergistic rubber accelerator prepared using the method set forth in Example 3.

The preparation method of the natural rubber products is as follows: premixing the entire above accelerator into white carbon black, then blending the mixture with the above amount of natural rubber for 5 min, and then adding the entire sulfur powder and mixing for 2 min, where an XK-160 open mill is used for mixing, the mixing process parameters are as follows: mixing at room temperature for 4 min at a rotating speed of 25 rpm with a roller distance of 2 mm, and triangle packing at least 3 times; then calendaring using a q160 double-roller rocking calender for shaping, where the process parameters for calendaring are as follows: the temperature is set lower than 70° C., the equipment operation lead coefficient P=1.1 (a ratio of the material outlet speed to the roller linear speed), and the roller speed ratio is 1.1-1.3; and finally, vulcanizing the product at 150° C. for 10 min, so as to obtain the natural rubber product.

### Examples 4-16 and Comparative Examples 1-3

The difference between Examples 4-16, Comparative Examples 1-3 and Example 2 is that the accelerator is prepared by different methods, see Table 1 for details.

TABLE 1
Sources of accelerators in different examples

| | | | | | | |
|---|---|---|---|---|---|---|
| Solution of | Example | Example | Example 5 | Example 6 | Example 7 | Example |
| natural | 2 | 4 | | | | 8 |
| rubber | | | | | | |
| product | | | | | | |
| Source of | Example | Example | Example 5 | Example 6 | Example 7 | Example |
| bimetallic | 2 | 4 | | | | 8 |
| synergistic | | | | | | |
| rubber | | | | | | |
| accelerator | | | | | | |
| Solution of | Example | Example | Example 11 | Example 12 | Example 13 | Example |
| natural | 9 | 10 | | | | 14 |
| rubber | | | | | | |
| product | | | | | | |
| Source of | Example | Example | Example 11 | Example 12 | Example 13 | Example |
| bimetallic | 9 | 10 | | | | 14 |
| synergistic | | | | | | |
| rubber | | | | | | |
| accelerator | | | | | | |
| Solution of | Example | Example | Comparative | Comparative | Comparative | |
| natural | 15 | 16 | Example 1 | Example 2 | Example 3 | |
| rubber | | | | | | |
| product | | | | | | |
| Source of | Example | Example | Comparative | Comparative | Comparative | |
| bimetallic | 15 | 16 | Example 1 | Example 2 | Example 3 | |
| synergistic | | | | | | |
| rubber | | | | | | |
| accelerator | | | | | | |

### Comparative Example 4

The difference between this comparative example and Example 2 lies in the selection of the accelerator. The accelerator in Example 2 is replaced with an equal amount of CBS (also known as accelerator CZ or N-cyclohexyl-2-benzothiazole sulfenamide), and the rest components are the same as those in Example 2.

The obtained natural rubber products are tested for performance. The specific results are shown in Table 2 below.

TABLE 2
Performance of different natural rubber products

| | | | | 300% | | |
|---|---|---|---|---|---|---|
| | | | Elongation | Mechanical | | Crack |
| | | Vulcanization | at | properties/ | Hardness/ | resistance/ |
| Test Indicator | | time/ min | break/ % | MPa | HA | [KN/m] |
| Natural | Example 1 | 10 | 450 | 10 | 70 | 75 |
| rubber | Example 2 | 8 | 550 | 15 | 80 | 90 |
| product | Example 3 | 6 | 610 | 18 | 85 | 100 |
| | Example 4 | 9 | 490 | 13 | 80 | 85 |
| | Example 5 | 8 | 530 | 16 | 90 | 88 |
| | Example 6 | 8 | 520 | 14 | 85 | 88 |
| | Example 7 | 9 | 500 | 11 | 75 | 80 |
| | Example 8 | 10 | 480 | 12 | 77 | 83 |
| | Example 9 | 8 | 550 | 15 | 80 | 90 |
| | Example 10 | 8 | 540 | 14 | 78 | 85 |
| | Example 11 | 8 | 530 | 14 | 78 | 88 |
| | Example 12 | 8 | 550 | 15 | 80 | 90 |
| | Example 13 | 6 | 610 | 18 | 85 | 100 |
| | Example 14 | 6 | 610 | 18 | 85 | 100 |
| | Example 15 | 9 | 470 | 11 | 75 | 82 |
| | Example 16 | 10 | 540 | 15 | 80 | 95 |
| | Comparative | 12 | 420 | 7 | 65 | 60 |
| | Example 1 | | | | | |
| | Comparative | 11 | 490 | 10 | 55 | 75 |
| | Example 2 | | | | | |
| | Comparative | 14 | 420 | 7 | 65 | 60 |
| | Example 3 | | | | | |
| | Comparative | 13 | 450 | 8 | 60 | 70 |
| | Example 4 | | | | | |

It can be seen from the data of the results of Examples 1-16 and Comparative Examples 1-4 shown in Table 2 that the accelerator of the present application can improve the overall performance of rubber products on the premise of shortening the vulcanization time.

Specifically, in Example 2 and Examples 4-7, when the pre-precursor powder is prepared by the sol-gel method, the effect of the molar ratio of cobalt nitrate to manganese acetate on the properties of the rubber products has been studied. It has been found that when the molar ratio of cobalt nitrate to manganese acetate is within the range of 1: (1-3), the vulcanization time of the obtained rubber products is short and the overall performance thereof is relatively excellent and maintained at a high level.

Based on Comparing Example 2, Examples 8-10 and Comparative Example 1, it has been that in the case where the pre-precursor powder is prepared by the sol-gel method and the reaction temperature is 50-70° C., the vulcanization time of the rubber products is short and the obtained rubber product has excellent overall properties. However, it has also been found that when the temperature is 60-70° C., the vulcanization time of rubber products and the overall performance thereof do not change. Therefore, from the perspective of energy saving, a reaction temperature of 50-60° C. is preferred.

Moreover, in Example 2 and Examples 11-14, the influence of the weight ratio of the pre-precursor powder to sulfur powder on the rubber products in the microwave synthesis is further investigated. The results show that when the weight ratio of the pre-precursor powder to sulfur powder is within the range of 1: (1.5-4.5), for the same vulcanization time, the overall performance of the rubber products obtained are consistent. However, similarly when considering the cost issue, it is recommended that the weight ratio of the pre-precursor powder to sulfur powder be set within the range of 1: (1.5-3.5).

In addition, based on Example 2 and Examples 15-16, it has been found that the particle size of the bimetallic synergistic rubber accelerator has a greater impact on the rubber products. The particle size of the accelerator directly affects the reactive specific surface area of the accelerator, which directly affects the performance of the rubber products.

When preparing the accelerator, the choice of the bimetal components is also crucial. For example, the copper-zinc bimetallic accelerator in Comparative Example 2 and the iron-nickel bimetallic accelerator in Comparative Example 3 have poor accelerator effect. The foregoing two mainly show that the rubber vulcanization time is long, and the tear strength, elongation at break, hardness and tensile stress strain properties are low. When preparing the rubber product with the conventional accelerator obtained in Comparative Example 4, the vulcanization time is long, and the tear strength, hardness and tensile stress strain properties of the rubber product are low.

### Examples of Rubber Products

The following examples of rubber products are obtained using nitrile rubber as the raw material, specifically involving the nitrile rubber products based on Examples 1-3 and the nitrile rubber products based on Comparative Examples 1-3.

### Examples of Nitrile Rubber Products

### Example 1

The raw materials and the amounts thereof for preparing the nitrile rubber product are as follows: 100 g nitrile rubber powder, 2 g accelerator, 0.2 g dibenzoyl peroxide, and 30 g silica powder. The accelerator is prepared using the bimetallic synergistic rubber accelerator prepared using the method of Example 1.

The preparation method of the nitrile rubber product is as follows: premixing the entire above accelerator into silica powder, then blending the mixture with the above amount of nitrile rubber for 5 min, then adding the entire dibenzoyl peroxide and mixing for 2 min, and then using an internal mixer with model BR160 to mix, where the mixing process parameters are as follows: 3 minutes of internal mixing at room temperature, and then 1 minute of internal mixing after the temperature being raised to 70° C.; then calendaring using a 160 double-roller rocking calender for shaping, where the process parameters for calendaring are as follows: the equipment operation lead coefficient P=1.1 (a ratio of the material outlet speed to the roller linear speed), and the roller speed ratio is 1.1-1.3; and finally, vulcanizing the product at 140° C. for 6 min, so as to obtain the nitrile rubber product.

### Example 2

The raw materials and the amounts thereof for preparing the nitrile rubber product are as follows: 100 g nitrile rubber powder, 3 g accelerator, 0.8 g dibenzoyl peroxide, and 40 g silica powder. The accelerator is prepared using the bimetallic synergistic rubber accelerator prepared using the method of Example 2.

The preparation method of the nitrile rubber product is the same as in Example 1.

### Example 3

The raw materials and the amounts thereof for preparing the nitrile rubber product are as follows: 100 g nitrile rubber powder, 4 g accelerator, 1.4 g dibenzoyl peroxide, and 50 g silica powder. The accelerator is prepared using the bimetallic synergistic rubber accelerator prepared using the method of Example 3.

The preparation method of the nitrile rubber product is the same as in Example 1.

### Comparative Examples 1-2

The difference between Comparative Examples 1-2 and Example 2 is that the accelerator is prepared by different methods; see Table 3 below for details.

TABLE 3
Sources of accelerators in different solutions

| | | | |
|---|---|---|---|
| Solution of nitrile rubber product | Example 2 | Comparative | Comparative |
| | | Example 1 | Example 2 |
| Source of bimetallic synergistic | Example 2 | Comparative | Comparative |
| rubber accelerator | | Example 2 | Example 3 |

### Comparative Example 3

The difference between this comparative example and Example 2 is that the accelerator is selected differently, where the accelerator of Example 2 is replaced with an equal amount of TBBS (N-tert-butyl-2-benzothiazole sulfenamide), and the rest components are the same as those in Example 2.

The performance of the obtained nitrile rubber products is tested. The specific results are shown in Table 4 below.

TABLE 4
Performance of different nitrile rubber products

| | | | | 300% | | |
|---|---|---|---|---|---|---|
| | | | Elongation | Mechanical | | Crack |
| | | Vulcanization | at | properties/ | Hardness/ | resistance/ |
| Test Indicator | | time/ min | break/ % | MPa | HA | [KN/m] |
| Nitrile | Example 1 | 6 | 380 | 8 | 65 | 70 |
| rubber | Example 2 | 5 | 450 | 10 | 70 | 80 |
| product | Example 3 | 4 | 510 | 12 | 75 | 90 |
| | Comparative | 7 | 350 | 6 | 60 | 65 |
| | Example 1 | | | | | |
| | Comparative | 7 | 350 | 6 | 60 | 65 |
| | Example 2 | | | | | |
| | Comparative | 8 | 350 | 6 | 60 | 60 |
| | Example 3 | | | | | |

It can be seen from the data shown in Table 2 that in the case of preparing nitrile rubber products, when the accelerator of the present application is used as a raw material, the vulcanization time is short, and the overall performance of the rubber products is also improved.

The specific examples are merely for explaining the present application, and they are not limitation to the present application. After reading the description, a person skilled in the art may make modifications to the examples as needed without creative contribution. However, as long as they are within the scope of the claims of the present application, they are also within the scope of protection according to the patent law.

1. A method for preparing a bimetallic synergistic rubber accelerator, characterized in that the method comprises the following steps: Step S1, preparing a pre-precursor powder by a sol-gel method; Step S2, performing microwave synthesis;
the Step S1 specifically comprises the following steps:
Step S11: dissolving a cobalt salt and a manganese salt in water, adding polyethylene glycol and then stirring evenly, and adjusting the pH to 7.5-8 with an alkali solution to obtain an initial reaction solution;
Step S12: reacting the initial reaction solution at 50-70° C., then drying to obtain a xerogel, and then pulverizing and screening to obtain the pre-precursor powder;
the Step S2 specifically comprises the following steps:
mixing the pre-precursor powder and a sulfur powder evenly, then reacting in a microwave environment, and then screening to obtain the bimetallic synergistic rubber accelerator.

2. The method for preparing a bimetallic synergistic rubber accelerator according to claim 1, characterized in that in Step S11, when the cobalt salt and the manganese salt are dissolved in water, a molar ratio of cobalt ions to manganese ions is 1: (1-3);
preferably, in Step S11, when the polyethylene glycol is added, a content of the polyethylene glycol made to 1.5-3.0 wt %;
preferably, the cobalt salt is any one or more selected from cobalt nitrate, cobalt chloride and cobalt phosphate; and the manganese salt is any one or more selected from manganese acetate, manganese carbonate and manganese sulfate.

3. The method for preparing a bimetallic synergistic rubber accelerator according to claim 1, characterized in that a reaction time in Step S12 is 20-30 h;
preferably, a reaction temperature in Step S12 is 50-60° C.

4. The method for preparing a bimetallic synergistic rubber accelerator according to claim 1, characterized in that the microwave environment in Step S2 comprises: a temperature is 195-205° C., a microwave processing time is 5-15 min, and a microwave power is 700-900 W;
preferably, the microwave synthesis in Step S2 is performed in a vacuum environment.

5. The method for preparing a bimetallic synergistic rubber accelerator according to claim 1, characterized in that the pre-precursor powder and sulfur powder in Step S2 are mixed at a weight ratio of 1: (1.5-3.5).

6. The method for preparing a bimetallic synergistic rubber accelerator according to claim 1, characterized in that the bimetallic synergistic rubber accelerator is used after the screening, and after the screening, a particle size Dt of the bimetallic synergistic rubber accelerator is: 0<Dt<100 meshes.

7. The bimetallic synergistic rubber accelerator, characterized in that the accelerator is prepared by the preparation method according to claim 1.

8. A rubber product, characterized in that raw materials for preparing the rubber product comprise the bimetallic synergistic rubber accelerator according to claim 7.

9. The rubber product according to claim 8, characterized in that when the rubber product is a natural rubber product, the rubber product comprises the following raw materials in parts by weight: 100 parts of natural rubber, 0.5-3.5 parts of metal the synergistic rubber accelerator, 0.2-0.8 parts of a vulcanizing agent, and 23-36 parts of an inorganic filler;
preferably, the vulcanizing agent is sulfur powder, and the inorganic filler is white carbon black.

10. The rubber product according to claim 8, characterized in that when the rubber product is a nitrile rubber product, the rubber product comprises the following raw materials in parts by weight: 100 parts of nitrile rubber, 2-4 parts of the metal synergistic rubber accelerator, 0.2-1.4 parts of a vulcanizing agent, and 30-50 parts of an inorganic filler;
preferably, the vulcanizing agent is a peroxide vulcanizing agent, and the inorganic filler is silica powder.
